(19) United States
(12) Patent Application Publication
(10) Pub. No.: US 2025/0166435 A1
(43) Pub. Date: May 22, 2025

(54) INFORMATION PROCESSING APPARATUS

(71) Applicant: TOYOTA JIDOSHA KABUSHIKI KAISHA, Toyota-shi (JP)

(72) Inventors: Keisuke OMURO, Toyota-shi (JP); Atsushi TABATA, Okazaki-shi (JP); Kichi OKUDA, Toyota-shi (JP); Hideaki BUNAZAWA, Tokyo (JP)

(73) Assignee: TOYOTA JIDOSHA KABUSHIKI KAISHA, Toyota-shi (JP)

(21) Appl. No.: 18/937,026

(22) Filed: Nov. 5, 2024

(30) Foreign Application Priority Data
Nov. 16, 2023 (JP) 2023-195060

(51) Int. Cl. G07C 5/10; B60T 1/00; G07C 5/08

(52) U.S. Cl. CPC G07C 5/10; B60T 1/005; G07C 5/0816

(57) ABSTRACT

The processing device of the information processing apparatus includes: a first step of calculating a relative frequency distribution of the original data; a second step of setting a plurality of time windows for cutting data for a partial period of the original data; a third step of cutting data from the original data; a fourth step of calculating a relative frequency distribution in extracted data; and a fifth step of calculating an error between the relative frequency distribution in the original data and the relative frequency distribution in the extracted data, and performs a search process of repeatedly executing the trial from the second step to the fifth step by changing settings of the time windows. The processing device calculates an index value of damage of the parking lock mechanism by using the extracted data in which the error becomes equal to or smaller than the threshold value.

### CROSS-REFERENCE TO RELATED APPLICATION

This application claims priority to Japanese Patent Application No. 2023-195060 filed on Nov. 16, 2023, incorporated herein by reference in its entirety.

### BACKGROUND

### 1. Technical Field

The present disclosure relates to an information processing apparatus.

### 2. Description of Related Art

Japanese Unexamined Patent Application Publication No. 2008-108247 (JP 2008-108247 A) discloses an information processing apparatus that reduces the size of data for analysis by compressing original data for analysis. The original data for analysis are data collected over a predefined period using a sensor mounted on a vehicle.

The information processing apparatus disclosed in JP 2008-108247 A compresses data by extracting, from the original data, data acquired at the time when a constant vehicle speed is reached and data acquired at the time of an inflection point of the vehicle speed.

### SUMMARY

The above information processing apparatus extracts data by focusing only on the vehicle speed. Therefore, the above information processing apparatus cannot extract data according to features of data other than the vehicle speed. There is a demand for an information processing apparatus capable of obtaining extracted data in which features of the entire original data including a plurality of feature amounts are captured.

In order to address the above issue, an aspect provides an information processing apparatus that acquires original data collected and prepared over a predefined period using a plurality of sensors mounted on a vehicle, and that calculates an index value indicating a magnitude of damage accumulated in a parking lock mechanism, including:
a processing device that executes a process, in which:
the original data include, as a feature amount, data on an inclination angle of the vehicle at a time when a lock pawl is engaged with a parking gear in the parking lock mechanism; and
the processing device is configured to
execute a search process including a first step of calculating a relative frequency distribution for the feature amount included in the original data in the original data, a second step of setting a plurality of time windows for cutting data for a partial period of the original data such that a period obtained by totaling periods of all the time windows is shorter than a period of all of the original data, a third step of cutting data from the original data according to the time windows, a fourth step of calculating a relative frequency distribution in extracted data obtained by combining all the data cut according to the time windows, and a fifth step of calculating an error between the relative frequency distribution in the original data and the relative frequency distribution in the extracted data, the second step to the fifth step being executed, after the first step is executed, repeatedly while changing settings of the time windows to extract extracted data that render the error equal to or less than a threshold value, and
calculate the index value using the extracted data that render the error equal to or less than the threshold value.

The information processing apparatus described above can calculate the index value using the extracted data with the same accuracy as in the case where the original data are used. Thus, according to the information processing apparatus described above, it is possible to calculate the index value in a shorter time than in the case where the original data are used.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a relationship between a data center, a vehicle, and an information processing terminal, which is an embodiment of an information processing apparatus;

FIG. 2 is a perspective view of a parking lock mechanism;

FIG. 3 is a graph showing a portion of the original data;

FIG. 4 is a flowchart illustrating a flow of processing executed by the processing device of the data center;

FIG. 5 is a relative frequency distribution for the inclination angle of the vehicle in the original data, showing the distribution of relative frequencies in a positive range of classes;

FIG. 6 is a relative frequency distribution for the inclination angle of the vehicle in the original data, showing the distribution of relative frequencies in a negative range of classes; and

FIG. 7 is a relative frequency distribution for the inclination angle of the vehicle in the original data, showing the relative power in a class in the range of 0.

### DETAILED DESCRIPTION OF EMBODIMENTS

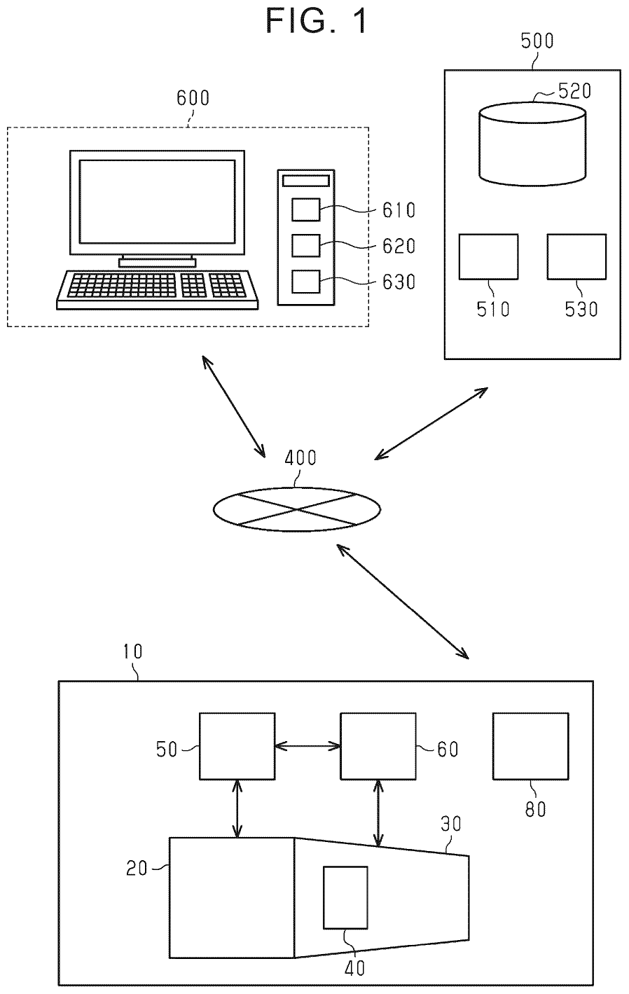

Hereinafter, the data center 500, which is an embodiment of the information processing apparatus, will be described with reference to FIG. 1 to FIG. 7.

### Configuration of Information Processing System

FIG. 1 shows a configuration of an information processing system including a data center 500. As shown in FIG. 1, the data center 500 communicates with the vehicle 10 via a communication network 400. The data center 500 also communicates with the information processing terminal 600 via the communication network 400. The data center 500 communicates with the plurality of vehicles 10 and the plurality of information processing terminals 600 via the communication network 400.

### Configuration of Data Center 500

As illustrated in FIG. 1, the data center 500 includes a processing device 510. The data center 500 includes a storage device 520 and a communication device 530. The processing device 510 includes a CPU that executes processing in accordance with a program, and a ROM in which the program is stored. The storage device 520 stores a large amount of data. The communication device 530 is implemented as hardware such as a network adapter, various communication software, or a combination thereof. The communication device 530 realizes wired or wireless communication via the communication network 400.

The data center 500 may be configured using a plurality of computers. For example, the data center 500 may be configured by a plurality of server apparatuses.

### Structure of Vehicle 10

Each of the plurality of vehicles 10 includes a communication device 80. The communication devices 80 are implemented as hardware such as a network adapter, various communication software, or a combination thereof. These communication devices 80 are configured to realize wired or wireless communication via the communication network 400.

Each vehicle 10 is equipped with an engine 20 and an automatic transmission 30. For example, the automatic transmission 30 is a planetary gear type transmission. The automatic transmission 30 includes a parking lock mechanism 40.

The vehicle 10 includes an engine control device 50 and a transmission control device 60. The engine control device 50 controls the engine 20. The transmission control device 60 controls the automatic transmission 30. The parking lock mechanism 40 is also controlled by the transmission control device 60.

The engine control device 50 and the transmission control device 60 are equipped with various sensors that collect information on each part of the vehicle 10. In each vehicle 10, travel data is collected from the various sensors. The traveling data is transmitted from each vehicle 10 to the data center 500 by the communication device 80. For example, travel data including the travel distance, the position information, and the vehicle speed of each vehicle 10 is transmitted from each vehicle 10 to the data center 500. The travel data also includes various data indicating the state of the automatic transmission 30 acquired by the transmission control device 60 of the vehicle 10. The traveling data also includes data indicating the state of the parking lock mechanism 40. Identification information for identifying the respective vehicles 10 is also transmitted from the respective vehicles 10 to the data center 500 together with the traveling data.

The data center 500 stores the traveling data together with the received identification information in the storage device 520. In this way, traveling data of the plurality of vehicles 10 is accumulated in the storage device 520 of the data center 500.

### Configuration of Parking Lock Mechanism 40

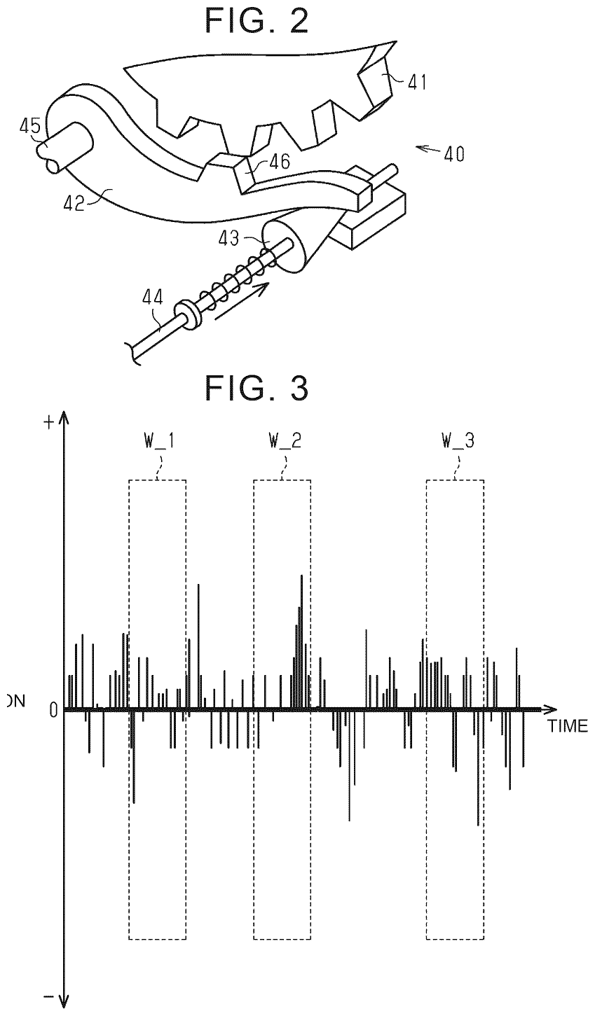

As shown in FIG. 2, the parking lock mechanism 40 includes a parking gear 41 and a lock pawl 42 provided with a locking piece 46. The parking lock mechanism 40 is housed in a case of the automatic transmission 30. The parking gear 41 is fixed to an output shaft of the automatic transmission 30 interlocked with the drive wheels. The lock pawl 42 is attached to the case of the automatic transmission 30 so as to rotate about the support shaft 45. The parking lock mechanism 40 mechanically restricts the rotation of the output shaft of the automatic transmission 30 by rotating the lock pawl 42 toward the parking gear 41 around the support shaft 45 and engaging the locking piece 46 with the parking gear 41. Accordingly, the parking lock mechanism 40 restricts the rotation of the drive wheels.

The parking lock mechanism 40 includes a parking gear 41 and a rod 44 driven by an actuator in addition to the lock pawl 42. The distal end portion of the rod 44 is provided with a tapered portion 43 that narrows toward the distal end side. The lock pawl 42 is in contact with the tapered portion 43. In the parking lock mechanism 40, the rod 44 is moved in the axial direction by being driven by an actuator. As the rod 44 moves in the axial direction, the lock pawl 42 that is in contact with the tapered portion 43 rotates about the 15 support shaft 45.

The state shown in FIG. 2 is a state in which the parking lock mechanism 40 is unlocked. In this state, the rotation of the drive wheels is not restricted by the parking lock mechanism 40.

When the rod 44 is moved in the direction of the arrow shown in FIG. 2 by the actuator from this state, the lock pawl 42 is pushed up toward the parking gear 41 by the tapered portion 43. Then, when the locking piece 46 of the lock pawl 42 is pushed up to a position where it meshes with the parking gear 41, the rotation of the drive wheels rotating in conjunction with the parking gear 41 is mechanically restricted.

As described above, the parking lock mechanism 40 realizes the parking lock that restricts the rotation of the drive wheels by engaging the lock pawl 42 with the parking gear 41.

When the actuator moves the rod 44 in the direction opposite to the arrow shown in FIG. 2 from the state where the parking lock is applied, the lock pawl 42 pushed up by the tapered portion 43 is lowered. As a result, the locking piece 46 of the lock pawl 42 is separated from the parking gear 41 and the parking lock is released.

### Configuration of Information Processing Terminal 600

The information processing terminal 600 includes a processing device 610, a storage device 620, and a communication device 630. The processing device 610 includes a CPU that executes processing in accordance with a program, and a ROM in which the program is stored. The storage device 620 stores data. The communication device 630 is implemented as hardware such as a network adapter, various communication software, or a combination thereof. The communication device 630 realizes wired or wireless communication via the communication network 400. The information processing terminal 600 is, for example, a personal computer.

### Analysis of Travel Data of Vehicle 10

The information processing terminal 600 is used to analyze travel data. When analyzing the traveling data, an instruction for executing the analysis is transmitted from the information processing terminal 600 to the data center 500. The processing device 510 of the data center 500 that has received the instruction performs analysis using a part of travel data among the enormous travel data stored in the storage device 520 of the data center 500. The travel data to be used is selected from the enormous amount of travel data stored in the storage device 520 in accordance with the purpose of analysis.

For example, the processing device 510 calculates a load applied to a specific component of the specific vehicle 10 based on travel data of the specific vehicle 10. The processing device 510 estimates the damage accumulated in the component based on the calculated load. For example, the processing device 510 calculates an index value indicating the magnitude of the damage accumulated in the parking lock mechanism 40 of the specific vehicle 10 based on the traveling data of the specific vehicle 10. The processing device 510 of the data center 500 outputs the calculated result by transmitting the calculated result to the information processing terminal 600. The information processing terminal 600 that has received the result displays the received result.

In order to perform such an analysis, the processing device 510 analyzes a large amount of travel data collected over a long period of time. Since the processing device 510 needs to perform an enormous amount of computation, it takes a long time to analyze.

Therefore, it is conceivable to extract the extracted data that captures the features of the entire original data from a large amount of travel data that is the original data. If such extracted data can be extracted, the processing device 510 can perform analysis in a shorter time by using the extracted data. For example, when estimating the damage of the parking lock mechanism 40 used for 0.1 million hours, the processing device 510 estimates the damage using the extracted data for 20000 hours extracted from the original data for 0.1 million hours. Note that the original data of 0.1 million hours in the case of this embodiment is data obtained by extracting data of a period during which the parking lock mechanism 40 is operating from the traveling data by 0.1 million hours. Then, the processing device 510 calculates an index value of damage when the parking lock mechanism 40 is used for 0.1 million hours by multiplying the index value calculated from the extracted data for 20000 hours extracted from the original data for 0.1 million hours by 5.

FIG. 3 shows a portion of the original data. The original data illustrated in FIG. 3 is original data for 0.1 million hours in one vehicle 10. The original data illustrated in FIG. 3 includes data of the inclination angle of the vehicle 10 as the feature amount. When the inclination angle of the vehicle 10 is a positive value, it indicates that the vehicle 10 is on an uphill slope. The inclination angle of the vehicle 10 indicates that the vehicle 10 is on a slope of a downward slope when the inclination angle is a negative value. The inclination angle of the vehicle 10 can be detected by a G sensor mounted on the vehicle 10. The G sensor is a sensor that detects acceleration. For example, the G sensor is a three-axis acceleration sensor capable of detecting acceleration in the front-rear direction, acceleration in the left-right direction, and acceleration in the up-down direction of the vehicle 10.

FIG. 3 is data in which the inclination angle of the vehicle 10 when the parking lock mechanism 40 is used, that is, when the lock pawl 42 is engaged with the parking gear 41 in the parking lock mechanism 40 is summarized in chronological order.

The inclination angle of the vehicle 10 when the lock pawl 42 is engaged with the parking gear 41 is correlated with the damage of the parking lock mechanism 40. The processing device 510 estimates the damage of the parking lock mechanism 40 by using, as the feature amount, extracted data including data on the inclination angle of the vehicle 10 when the lock pawl 42 is engaged with the parking gear 41.

The extracted data is created by clipping the data from the original data by a plurality of time windows. In FIG. 3, as an example of a plurality of time windows, three time windows of the first time window W_1, the second time window W_2, and the third time window W_3 are indicated by broken lines. The beginning and end of each time window are set such that the respective time windows do not overlap. In this example, data of 20000 hours is extracted as the extracted data. Therefore, the start and end periods of each time window are set so that the total length of the time periods of all the time windows is 20000 hours.

The data center 500 searches for the setting of the start time and the end time of each time window indicating the cut-out pattern for extracting the extracted data that captures the features of the entire original data.

The data center 500 extracts the extracted data from the original data by using the cut-out pattern found by the search. The data center 500 performs analysis using the extracted data.

### Logging Pattern Search Process

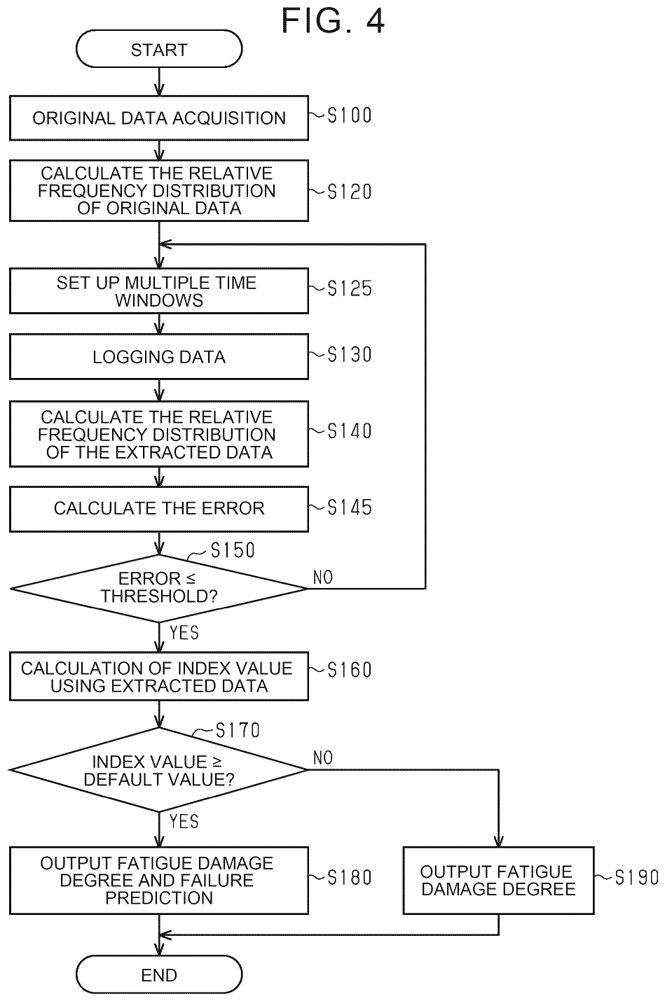

FIG. 4 is a flowchart illustrating a flow of a series of processes related to the extraction pattern search process. This series of processing is executed by the processing device 510 of the data center 500.

As illustrated in FIG. 4, the processing device 510 acquires the original data in the processing of S100. The original data is a part of the travel data selected for the purpose of analysis from the enormous travel data stored in the storage device 520 of the data center 500. For example, the original data for calculating the index value indicating the magnitude of the damage accumulated in the parking lock mechanism 40 of one vehicle 10 is travel data over a predetermined period of the target vehicle 10 selected from the huge travel data of the plurality of vehicles 10. For example, the processing device 510 estimates damage to the parking lock mechanism 40 when the parking lock mechanism is used for 0.1 million hours. In this case, the original data is data obtained by extracting the data of the period in which the parking lock mechanism 40 is used for 0.1 million hours from the traveling data of the target vehicle 10 over the predetermined period.

Next, the processing device 510 calculates the relative frequency distribution of the original data in the processing of S120. As described above, the original data includes data on the inclination angle of the vehicle 10 as the feature amount. The processing device 510 calculates the relative frequency distribution in the original data with respect to the inclination angle of the vehicle 10.

The frequency distribution classifies data into a plurality of classes, and represents a frequency distribution that is the number of data of each class. The relative frequency indicates how much the frequency of the class accounts for the sum of the total frequencies.

The processing device 510 divides the calculated relative velocity distribution into a relative frequency distribution of a class in a positive range, a relative frequency distribution of a class in a negative range, and a relative frequency distribution of a class in a range of 0.

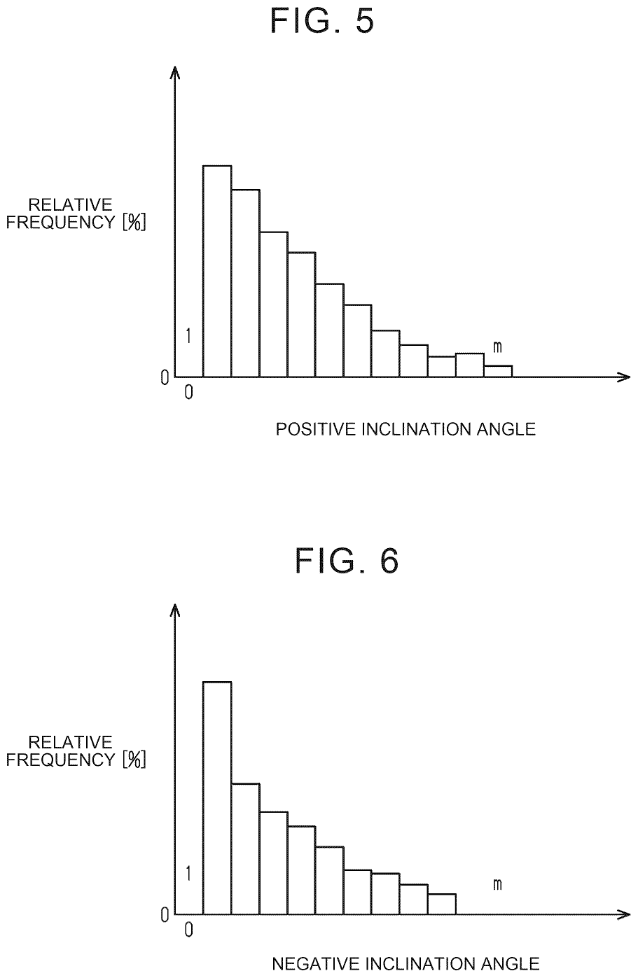

FIG. 5 shows the relative frequency distribution of the class in the positive range among the relative frequency distributions of the inclination angle of the vehicle 10 in the original data shown in FIG. 3. In this relative frequency distribution, the rank of the inclination angle in the original data is set as “1” in the range of 0, and the relative frequency distribution is shown by dividing the rank into m ranks up to “m”. FIG. 5 shows a class in which the absolute value of the inclination angle is larger in the right class.

FIG. 6 shows the relative frequency distribution of the class in the negative range among the relative frequency distributions for the inclination angle of the vehicle 10 in the original data shown in FIG. 3. In this relative frequency distribution, the rank of the inclination angle in the original data is set as “1” in the range of 0, and the relative frequency distribution is shown by dividing the rank into m ranks up to “m”. FIG. 6 shows a class in which the absolute value of the inclination angle is larger in the right class.

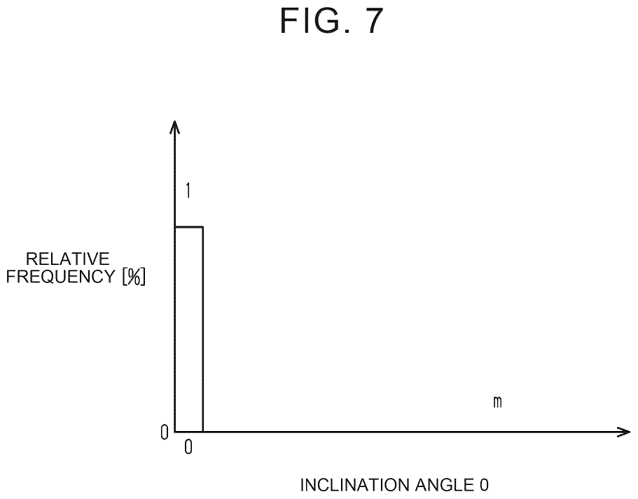

FIG. 7 shows the relative frequency distribution of the classes in the range of 0 among the relative frequency distributions for the inclination angle of the vehicle 10 in the original data shown in FIG. 3. In this relative frequency distribution, the relative frequencies other than the “1” class are all zero.

In S120 process, the processing device 510 calculates the relative frequency distribution for the inclination angle of the vehicle 10 in the original data. As shown in FIGS. 5 to 7, the number of classes in each relative frequency distribution is the same.

Next, in S125 process, the processing device 510 sets a plurality of time-windows in order to extract the extracted data from the original data.

FIG. 3 shows three time windows W_1 to W_3 of the first time window W_1, the second time window W_2, and the third time window W_3 as an example of a plurality of time windows. In the example shown in FIG. 3, the time periods of the respective time windows are all equal. As illustrated in FIG. 3, the data cut out by each cut-out window is data of a feature amount in the same period.

In S125 process, the processing device 510 randomly sets a plurality of time windows so that the total time period of all time windows is shorter than the total time period of the original data. As will be described later, the processing device 510 combines all the data cut out by the plurality of time windows set here to generate extracted data. The total time period of all the time windows is a value for determining the capacity of the extracted data. Therefore, a period in which all the time windows are summed is set in advance.

For example, the processing device 510 randomly sets the number of time windows, the start of each time window, and the end of each time window at each time S125 process is executed. At this time, the processing device 510 sets each time window so that each time window does not overlap. The processing device 510 thus randomly sets the plurality of time windows such that the total period of all time windows is a preset period. In S125 process, the processing device 510 may set a plurality of time windows by fixing the time periods of the time windows to be constant, as illustrated in FIG. 3. In S125 process, the processing device 510 may fix the plurality of time windows to a fixed number and set the plurality of time windows.

In this way, by setting a plurality of time-windows through S125 process, a cut-out pattern in which data is cut out from the original data is determined. When the processing device 510 determines the cut-out pattern in this way, the processing proceeds to S130.

In S130 process, the processing device 510 cuts out data from the original data in the determined cutout pattern. That is, in S130 process, the processing device 510 cuts out data from the original data by a plurality of set time-windows. Then, the processing device 510 combines all the data cut out by the plurality of time windows to create extracted data.

In the process of the following S140, the processing device 510 calculates the relative frequency distribution of the extracted data. The processing device 510 calculates the relative frequency distribution of the extracted data in the same manner as the method of calculating the relative frequency distribution in S120. In other words, in S140 process, the processing device 510 calculates the relative frequency distribution of the inclination angle in the extracted data. At this time, the processing device 510 sets the number of classes in the relative frequency distribution to be the same as the relative frequency distribution in S120.

Next, in S145 process, the processing device 510 calculates an error between the relative frequency distribution in the original data and the relative frequency distribution in the extracted data. For example, the processing device 510 calculates a mean absolute error (MAE). The mean absolute error MAE is expressed by the following equation.

$$MAE = \frac{1}{n} {\sum }_{i = 1}^{n} {\sum }_{j = 1}^{m} \vert {Y}_{nm} - {y}_{nm} \vert$$

In the above equation, “n” is the number of types of relative frequency distributions for which an error is obtained. In S145 process, the processing device 510 calculates an error in the relative velocity distribution of the class of the positive range, an error in the relative velocity distribution of the class of the negative range, and a relative frequency distribution of the range of 0, respectively. Thus, in this embodiment, “n” is 3. “m” is the number of series in the relative frequency distribution. “Y” is the frequency of the corresponding feature amount in the original data in the corresponding class. “y” is the frequency of the corresponding feature amount in the extracted data in the corresponding class.

As shown in the above equation, the processing device 510 calculates the sum of the errors of the frequencies in the respective classes of the feature amounts of the relative frequency distribution in the entire original data and the relative frequency distribution in the extracted data as an error.

After calculating the error, the processing device 510 advances the processing to S150. In S150 process, the processing device 510 determines whether or not the calculated error is less than or equal to the thresholds. The threshold value is a value for determining whether or not the extracted data having the relative frequency distribution close to the relative frequency distribution in the original data is extracted by the set cutout pattern. The magnitude of the threshold is set in advance so that it can be determined that extracted data having a relative frequency distribution close to the relative frequency distribution in the original data is extracted based on the error being equal to or smaller than the threshold.

In S150 process, when it is determined that the error is equal to or smaller than the threshold (S150: YES), the processing device 510 advances the process to S160. In S160 process, the processing device 510 calculates the target index value using the extracted data generated in the process of the latest S130. Here, the fatigue damage degree is calculated as an index value indicating the magnitude of damage accumulated in the parking lock mechanism 40.

The larger the inclination angle of the vehicle 10 when the lock pawl 42 is engaged with the parking gear 41, the larger the damage is accumulated in the parking lock mechanism 40. In addition, when the vehicle 10 is parked on the slope of the upward slope and when the vehicle 10 is parked on the slope of the downward slope, the site where the stress acts, the direction in which the stress acts, and the magnitude of the stress acting are different. Therefore, the processing device 510 calculates the fatigue damage degree of the parking lock mechanism 40 based on the inclination angle by selectively using the calculation contents based on the positive inclination angle and the negative inclination angle.

The fatigue damage degree is an index value representing a rate of accumulated fatigue, assuming that the damage of the parking lock mechanism 40 follows the linear cumulative damage law, the so-called minor law, with fatigue leading to damage as “1”. Here, the damage applied to the parking lock mechanism 40 during a certain period of time is calculated from the inclination angle. Then, the calculated ratio of the damage is calculated as an index value of the fatigue, with the magnitude of the damage that the friction material is damaged by the input of one load being set to “1”. By repeating this, the calculated index value of the fatigue is integrated to calculate the fatigue damage degree which is the ratio of the accumulated fatigue to the fatigue which reaches the damage. A fatigue damage degree of “1” means that the fatigue damage degree reaches damage, and the calculated fatigue damage degree is a value from “0” to “1”.

Here, since the fatigue damage degree is calculated using the extracted data which is a part of the original data, the processing device 510 converts the calculated fatigue damage degree into a size corresponding to the original data, and calculates the fatigue damage degree as the index value. For example, when the original data is data for 0.1 million hours and the extracted data is data for 20000 hours, the calculated fatigue damage degree is multiplied by 5 to obtain the fatigue damage degree as the index value.

On the other hand, in S150 process, when it is determined that the error is larger than the threshold (S150: NO), the processing device 510 returns the process to S125. Then, the processing device 510 re-executes the search processing from S125 to S145.

In this way, the processing device 510 repeatedly executes S145 search processing from S125 by changing the settings of the plurality of time-windows, and extracts extracted data in which the error becomes equal to or less than the threshold value from the original data. Then, in S160 process, the processing device 510 calculates the fatigue damage degree using the extracted data that is extracted. When the fatigue damage degree is calculated, the processing device 510 advances the processing to S170.

In S170 process, the processing device 510 determines whether or not the fatigue damage degree is equal to or greater than a predetermined value. The default value is a value for predicting that damage is more likely to occur based on the fatigue damage degree being equal to or greater than the default value. For example, “0.9” can be set here, for example, as a default value in the fatigue damage degree. In this case, based on the fact that 90% of the fatigue leading to damage has been reached, it is possible to predict that there is a high possibility of damage.

In S170 process, when it is determined that the fatigue damage degree is equal to or greater than the predetermined value (S170: YES), the processing device 510 advances the process to S180. In S180 process, the processing device 510 outputs the fatigue damage degree and the predicted failure. Specifically, the processing device 510 transmits the fatigue damage degree and the failure prediction to the information processing terminal 600 that has transmitted the instruction for requesting the analysis.

The failure prediction is, for example, a message indicating that the occurrence of a failure has been predicted. In this way, when the calculated fatigue damage degree is equal to or greater than the predetermined value, the processing device 510 notifies that the occurrence of the failure has been predicted. The failure prediction may be information of a lifetime until a failure occurs. For example, when the fatigue damage degree calculated by using the extracted data extracted from the original data for 0.1 million hours is the index value, the processing device 510 calculates the traveling time until the fatigue damage degree reaches “1” and outputs the calculated traveling time as the information of the life. The information on the life may be converted into the traveling distance based on the traveling distance of 0.1 million hours and output.

In S170 process, when it is determined that the fatigue damage degree is less than the predetermined value (S170: NO), the processing device 510 advances the process to S190. In S190 process, the processing device 510 outputs the fatigue damage degree. Specifically, the processing device 510 transmits the fatigue damage degree to the information processing terminal 600 that has transmitted the instruction for requesting the analysis.

When S180 or S190 process is executed, the processing device 510 terminates the series of processes.

### OPERATION OF THE EMBODIMENT

The data center 500, which is the information processing apparatus of the present embodiment, acquires original data collected and created over a predetermined period using a plurality of sensors mounted on the vehicle 10, and calculates an index value indicating the magnitude of damage accumulated in the parking lock mechanism 40.

The data center 500 includes a processing device 510 that executes processing. The original data includes data of the inclination angle of the vehicle 10 when the lock pawl 42 is engaged with the parking gear 41 in the parking lock mechanism 40 as a feature. In the data center 500, the search process executed by the processing device 510 includes a first step (S120) of calculating a relative frequency distribution in the original data with respect to the feature quantity included in the original data. The searching process includes a second step (S125) of setting a plurality of time windows for cutting out data of a part of the period of the original data such that the period of the total time of all the time windows is shorter than the period of the entire original data. The search process includes a third step (S130) of extracting data from the original data by a plurality of time-windows. The search process includes a fourth step (S140) of calculating a relative frequency distribution in the extracted data obtained by combining all the data cut out by the plurality of time-windows. The search process includes a fifth step (S145) of calculating an error between the relative frequency distribution in the original data and the relative frequency distribution in the extracted data. After executing the first step, the processing device 510 executes a search process in which the trials from the second step to the fifth step are repeatedly executed by changing settings of a plurality of time windows. Then, the processing device 510 extracts extracted data whose error becomes equal to or smaller than the threshold value. The processing device 510 calculates a fatigue damage degree as an index value using the extracted data in which the error becomes equal to or smaller than the threshold value (S160).

According to the data center 500, it is possible to obtain extracted data that captures the features of the entire original data. Therefore, the data center 500 can calculate the index value with the same accuracy as in the case of using the original data by using the extracted data.

### Effect of the Present Embodiment

(1) According to the data center 500 which is the information processing apparatus of the present embodiment, it is possible to calculate the index value in a shorter time than in the case where the original data is used.

(2) The processing device 510 divides the relative frequency distribution for the inclination angle into a relative frequency distribution of a class in a positive range, a relative frequency distribution of a class in a negative range, and a relative frequency distribution of a class in a range of 0 to calculate an error. Then, the processing device 510 calculates an index value by distinguishing damage in a case where the inclination angle is a positive value from damage in a case where the inclination angle is a negative value.

The direction of the stress acting on each portion of the parking lock mechanism 40 when the lock pawl 42 is engaged with the parking gear 41 and the portion where the stress acts differ between a case where the inclination angle of the vehicle 10 is positive and a case where the inclination angle is negative. Therefore, the magnitude of damage accumulated in the parking lock mechanism 40 when the inclination angle of the vehicle 10 is positive is different from the magnitude of damage accumulated in the parking lock mechanism 40 when the inclination angle of the vehicle 10 is negative.

The data center 500 calculates an index value by distinguishing damage in a case where the inclination angle of the vehicle 10 is a positive value from damage in a case where the inclination angle of the vehicle 10 is a negative value. Therefore, the data center 500 can calculate a more accurate index value as compared with a case where the index value is calculated without distinguishing between damage in a case where the inclination angle is a positive value and damage in a case where the inclination angle is a negative value.

(3) The data center 500 calculates an error by dividing the relative frequency distribution for the inclination angle into a relative frequency distribution of a class in a positive range, a relative frequency distribution of a class in a negative range, and a relative frequency distribution of a class in a range of 0. Therefore, the data center 500 can calculate the index value using the extracted data in which the relative frequency distribution for each range is close to the original data.

(4) The processing device 510 terminates the search process when one piece of extracted data whose error becomes equal to or smaller than the threshold value can be extracted, and calculates an index value using the extracted data whose error becomes equal to or smaller than the threshold value. Therefore, the data center 500 can calculate an index value at a time point when one piece of extracted data whose error becomes equal to or smaller than the threshold value can be extracted, and output the result promptly.

(5) When the calculated index value is equal to or greater than the predetermined value (S170: YES), the processing device 510 notifies that a failure has been predicted. Therefore, the data center 500 can notify the user that the occurrence of the failure has been predicted before the failure occurs.

(6) The processing device 510 calculates the fatigue damage degree as the index value. Therefore, the data center 500 can inform the user of how long the delay until the failure is reached.

### MODIFICATIONS

The present embodiment can be modified to be implemented as follows. The present embodiment and modifications described below may be carried out in combination within a technically consistent range.
In the data center 500 of the above-described embodiment, the processing device 510 calculates the index value by distinguishing damage in a case where the inclination angle is a positive value from damage in a case where the inclination angle is a negative value. On the other hand, the processing device 510 may calculate the index value by estimating the damage based on the magnitude of the inclination angle in both cases without distinguishing between the damage in the case where the inclination angle is a positive value and the damage in the case where the inclination angle is a negative value.
In the above embodiment, an example in which the information processing apparatus is embodied as the data center 500 has been described. An example in which the index value is calculated in the data center 500 has been described. On the other hand, the information processing apparatus described above may be embodied as the information processing terminal 600. In this case, the calculation of the index value is executed by the processing device 610 of the information processing terminal 600. The above-described information processing apparatus may be embodied as a control device of the vehicle 10. In this case, the calculation of the index value can also be performed by the control device of the vehicle 10. For example, the calculation of the index value may be performed by the transmission control device 60 of the vehicle 10.
In the above-described embodiment, an example has been described in which one piece of extracted data is extracted and an index value is calculated. On the other hand, a final index value may be determined by extracting a plurality of pieces of extracted data and using a plurality of index values calculated using the respective pieces of extracted data. For example, the minimum value, the maximum value, the mode value, and the average value are set as final index values. Further, a plurality of index values may be output.
In the above-described embodiment, an example has been described in which, when the index value is equal to or larger than a predetermined value, it is notified that the occurrence of a failure has been predicted. This may be omitted. After the index value is calculated, only S190 process may be executed, and only the index value may be outputted.
Although the fatigue damage degree is exemplified as an example of the index value to be calculated, the index value to be calculated is not limited to the fatigue damage degree.
The method of determining the setting of the time window in the cut-out pattern may not be random. The trial may be repeated by changing the setting of the time window in the clipping pattern according to a preset rule.
The error calculated in S145 process is not limited to the mean absolute error MAE. For example, the processing device 510 may calculate a mean square error as an error. The processing device 510 may calculate a root mean square error as an error.
The original data may include information on whether or not the side brake is used as the feature amount. When the side brake is used, damage to the parking lock mechanism 40 is reduced. Therefore, it is possible to estimate the damage of the parking lock mechanism 40 more accurately by referring to the information on whether or not the side brake is used.

What is claimed is:

1. An information processing apparatus that acquires original data collected and prepared over a predefined period using a plurality of sensors mounted on a vehicle, and that calculates an index value indicating a magnitude of damage accumulated in a parking lock mechanism, the information processing apparatus comprising a processing device that executes a process, wherein:
the original data include, as a feature amount, data on an inclination angle of the vehicle at a time when a lock pawl is engaged with a parking gear in the parking lock mechanism; and
the processing device is configured to
execute a search process including a first step of calculating a relative frequency distribution for the feature amount included in the original data in the original data, a second step of setting a plurality of time windows for cutting data for a partial period of the original data such that a period obtained by totaling periods of all the time windows is shorter than a period of all of the original data, a third step of cutting data from the original data according to the time windows, a fourth step of calculating a relative frequency distribution in extracted data obtained by combining all the data cut according to the time windows, and a fifth step of calculating an error between the relative frequency distribution in the original data and the relative frequency distribution in the extracted data, the second step to the fifth step being executed, after the first step is executed, repeatedly while changing settings of the time windows to extract extracted data that render the error equal to or less than a threshold value, and
calculate the index value using the extracted data that render the error equal to or less than the threshold value.

2. The information processing apparatus according to claim 1, wherein:
the processing device calculates the error by dividing the relative frequency distribution for the inclination angle into a relative frequency distribution of a class in a positive range, a relative frequency distribution of a class in a negative range, and a relative frequency distribution of a class in a range of 0; and
the index value is calculated separately for the damage for the inclination angle having a positive value and the damage for the inclination angle having a negative value.

3. The information processing apparatus according to claim 1, wherein the processing device terminates the search process when one piece of the extracted data that renders the error equal to or less than the threshold value is extracted, and calculates the index value using the piece of the extracted data that renders the error equal to or less than the threshold value.

4. The information processing apparatus according to claim 1, wherein the processing device makes a notification that occurrence of a failure is predicted when the calculated index value is equal to or more than a predefined value.

5. The information processing apparatus according to claim 1, wherein the processing device calculates a fatigue damage degree as the index value.
